(19) United States
(12) Patent Application Publication
(10) Pub. No.: US 2019/0204234 A1
(43) Pub. Date: Jul. 4, 2019

(54) Method And Apparatus Of Chemical Detection To Prevent Process Degradation

(71) Applicant: PostProcess Technologies, Inc., Buffalo, NY (US)

(72) Inventors: Daniel Joshua Hutchinson, Orchard Park, NY (US); Marc Farfaglia, Buffalo, NY (US); Cassidy Grant, Buffalo, NY (US)

(73) Assignee: PostProcess Technologies, Inc., Buffalo, NY (US)

(21) Appl. No.: 16/232,982

(22) Filed: Dec. 26, 2018

Related U.S. Application Data
(60) Provisional application No. 62/611,954, filed on Dec. 29, 2017.

(51) Int. Cl. G01N 21/78

(52) U.S. Cl. CPC G01N 21/78

(57) ABSTRACT

A method and an apparatus for detecting whether a liquid comprising one or more improper substances or an improper amount of one or more substances has been added to a system for removing support material from and/or smoothing a surface of a part made by additive manufacturing. The apparatus may have a sample material that is altered if the improper fluid contacts the sample material. The alteration may be due to characteristics of the improper fluid at the time the improper fluid is added to the system. In some embodiments of the invention, the sample material is capable of chemically reacting with the improper fluid. The apparatus also includes a sensor capable of detecting whether the sample material has been altered.

### CROSS-REFERENCE TO RELATED APPLICATION

This application claims the benefit of priority to U.S. provisional patent application Ser. No. 62/611,954, filed on Dec. 29, 2017 the entire disclosure of which is herein incorporated by reference.

### FIELD OF THE INVENTION

This invention relates generally to a method and apparatus for detecting whether a proper chemical is being used in a specific process for surface finishing and removing support material from parts made using additive manufacturing techniques such as 3D printing.

### BACKGROUND OF THE INVENTION

Additive manufacturing processes, such as 3D printing (e.g. Selective Laser Sintering (SLS), Polyjet, Stereolithography (SLA), etc.) have enabled the production of parts having complex geometries that would never be possible via traditional manufacturing technique, such as casting, injection molding, or forging. However, additive manufacturing produces parts that require significant efforts to remove unwanted support material. The support material is needed during the manufacturing process to support portions of the part as the part is being manufactured in order to achieve complex geometries. After the manufacturing process is completed, the support material is no longer needed and must be removed.

The support material itself can have a complex geometry and can also be extensive because the support material is often needed in order to support the part at a plurality of locations. Additionally, since additive manufacturing manufactures a part in discrete layers, the surface finish of a part is rough, with each layer having a portion that extends outward perpendicularly from the print direction, leaving a rough, bumpy outer surface. This outer surface is not only unappealing from a visual standpoint, but also the uneven surface can create stress concentrations, which could develop during testing or use of the part and lead to pre-mature failure.

A current option in the additive manufacturing industry is to manually remove the support material in order to produce a smooth exterior surface of the part. Depending on the type of part printed, using manual labor could be cost prohibitive and could lead to excessive removal of material, or an uneven surface, or both. If a surface is finished unevenly or incompletely, stress concentrations could be prevalent and lead to pre-mature failure. Even further, manual removal of unwanted support material and manual surface finishing lacks the ability to be consistent from part to part or over an extended period of time. Further, such manual removal/finishing may create a bottleneck in the production process since, for example, one technician can remove support material from only a single part at a time.

Another option that the additive manufacturing industry has been moving toward is using an automated machine, such as those providing a chemical bath, to remove support material and perform surface finishing. However, early versions of such machines have been limited in the type of process parameters that can be altered, such as varying only temperature, agitation level, fluid flow level. These prior-art machines also require the attention of—and operation by—a technician, thus not completely eliminating the bottleneck issue described above. Additionally, if a technician is unaware that a machine is not set at the proper parameters, excessive material removal could occur, thereby ruining the part. New and more sophisticated machines, such as those available from PostProcess Technologies, Inc., allow for greater flexibility a to alter and control process parameters while also requiring less attention from operators during operation.

As the additive manufacturing industry expands, new build and support materials are being utilized. Historically, additive manufacturing processes were limited to making plastic parts due to the ability of plastic to be manipulated with minimal heat and pressure. But as additive manufacturing evolved, the ability to use more robust and durable materials also evolved. Currently, additive manufacturing processes exist which will produce additional polymer-based parts as well as metal parts not only suitable as prototypes, but also as fully functional and market-ready parts. Even though previous methods of support material removal and surface finishing were plausible with parts made from plastic, such as applying abrasive material, chemical dissolution, and/or applying high temperature, the energy required to remove support material and perform surface finishing on metal parts is significantly greater.

Most current techniques for post processing of additive manufactured parts use highly concentrated and/or highly caustic chemicals that are not only dangerous to a human user, but also to components of the machine that is used to accomplish removal of support material and/or finishing the surface (“SR/SF”) of a part. Widely used chemicals for removing support material and surface finishing of additive manufactured parts include isopropyl alcohol (IPA), tripropylene glycol methyl ether (TPM), and/or potassium hydroxide (KOH). These chemicals are dangerous for humans to work with due to their low flashpoints and overwhelming vapors arising from their liquid form. Additionally, these chemicals can be harmful to components contained within a machine asked with SR/SF. For example, sensors, seals, and various other components could be damaged by being subject to highly concentrated and/or highly caustic chemicals. Machines that use these chemicals either require significant maintenance as components wear or fail from these chemicals, or must thus be rigorously designed to be able to withstand these chemicals. In the latter case, they may have been designed to withstand some chemicals but not others, and thus the use of improper chemicals can be problematic.

Additionally, newer techniques for post processing of additive manufactured parts, such as those provided by PostProcess Technologies, Inc., are able to use less concentrated and/or less caustic chemicals that are less dangerous to humans and components of machines. With use of these techniques, machines are subject to less wear and failure from the chemicals, and can be more easily designed to be able to withstand the chemicals. In these types of machines, however, it is important to not use chemicals that are more highly concentrated or caustic than the chemicals for which the machines were designed. It is therefore important to use the proper chemicals so as to achieve the desired SR/SF while also avoiding harm to the machine.

Some chemical manufacturers produce SR/SF products that are not formulated properly for a particular machine, whether of older or newer design or technique. Some users of a machine may use a chemical which is not proper for a particular machine. As a result, machines may fail prematurely and/or achieve undesirable results. As such, there is a need for a method and apparatus for detecting whether an improper chemical is being used for an SR/SF machine or process, enabling an SR/SF machine using the chemical to inform a user and/or also shut down the SR/SF machine to prevent damage to internal components of the machine and degradation of the process.

### SUMMARY OF THE INVENTION

An apparatus according to the invention may be employed to detect whether a liquid comprising one or more improper substances or an improper amount of one or more substances has been added to a system for removing support material from and/or smoothing a surface of a part made by additive manufacturing (the “AM part”). Such a liquid is referred to herein as an “improper fluid”. The apparatus may have a sample material that is altered if the improper fluid contacts the sample material. The alteration may be due to characteristics of the improper fluid at the time the improper fluid is added to the system. In some embodiments of the invention, the sample material is capable of chemically reacting with the improper fluid. The apparatus also includes a sensor capable of detecting whether the sample material has been altered.

Alteration of the sample may be with regard to a translucence of the sample material. In such an embodiment of the invention, the sensor includes a light detector. For example, the sensor may include a light source positioned on a first side of the sample material, and a light detector positioned on a second side of the sample material.

The apparatus may include a device that prevents the system from operating or provides a notification, or both, if the sensor detects that the sample material has been altered. For example, the apparatus may include an electronic circuit electrically coupled to the sensor, the electronic circuit being capable of preventing the system from removing support material from and/or smoothing a surface of the AM part if the sensor detects that the sample material has been altered.

Alteration of the sample material may be a degrading or dissolving of the sample material caused by contact with the improper fluid. In such an embodiment of the invention, the sensor may complete an electrical circuit when the sample material degrades or dissolves. Such a sensor may include a plunger positioned on a first side of the sample material, and a conductor positioned on a second side of the sample material.

In other embodiments of the invention, the sample material may release a color-changing substance if the improper fluid contacts the sample material, thereby altering a color of the improper fluid. In such an embodiment of the invention, the sensor detects a color of the improper fluid.

Other embodiments of the invention may have a sample material that releases a viscosity-changing substance if the improper fluid contacts the sample material thereby altering a viscosity of the improper fluid. In such an embodiment of the invention, the sensor detects a viscosity of the improper fluid.

In other embodiments of the invention, the sample material may release a thermal-conductivity-changing substance if the improper fluid contacts the sample material thereby altering a thermal-conductivity of the improper fluid. In such an embodiment of the invention, the sensor detects a thermal-conductivity of the improper fluid.

The invention may take the form of a system for removing support material from and/or smoothing the surface of an AM part. Such a system may include a detector capable of detecting whether an improper liquid has been added to the system. The detector may have a sample material that is altered if contacted by the improper liquid, and a sensor capable of detecting if the sample material has been altered. The sample material and/or sensor may be those summarized above.

The invention may take the form of a method for detecting whether an improper fluid has been added to a system for removing support material from and/or smoothing a surface of an AM part. Such a method may include providing a sample material that is altered if the improper fluid contacts the sample material, providing a sensor capable of detecting whether the sample material has been altered, and using the sensor to detect that the sample material has been altered. The alteration of the sample material may be due to characteristics of the improper fluid at the time the improper fluid is added to the system. If the sensor detects that the sample material has been altered, the system may be prevented from operating or providing a notification, or both. And, in such an event, the system may be prevented from removing support material from and/or smoothing a surface of the AM part if the sensor detects that the sample material has been altered.

Use of the sensor to detect may include detecting a translucence of the sample material.

Use of the sensor to detect may include detecting that the sample material has degraded or dissolved. And, detecting that the sample material has degraded or dissolved may include monitoring an electrical circuit to determine whether a state of the circuit (as either open or closed) has changed to the opposite state. Or, use of the sensor to detect may include detecting a color of the improper fluid. Or, use of the sensor to detect may include detecting a viscosity of the improper fluid. Or, use of the sensor to detect may include detecting a thermal conductivity of the improper fluid.

### DESCRIPTION OF THE DRAWINGS

The nature and mode of operation of the present invention will be more fully described in the following detailed description of the invention taken with the accompanying figures, in which:

FIG. 1A is a schematic depiction of a first embodiment of a chemical detection apparatus;

FIG. 1B is a flowchart describing a chemical detection method according to the first embodiment of the present invention;

FIG. 2A is a schematic view of a second embodiment of a chemical detection apparatus;

FIG. 2B is a flowchart describing a chemical detection method according to the second embodiment of the present invention;

FIG. 3A is a schematic view of a third embodiment of a chemical detection apparatus;

FIG. 3B is a flowchart describing a chemical detection method according to the third embodiment of the present invention;

FIG. 4A is a schematic view of a fourth embodiment of the chemical detection apparatus;

FIG. 4B is a flowchart describing a chemical detection method according to the fourth embodiment of the present invention;

FIG. 5A is a schematic view of a fifth embodiment of a chemical detection apparatus;

FIG. 5B is a flowchart describing a chemical detection method according to the fifth embodiment of the present invention;

FIG. 6A is a perspective view of an SR/SF machine that submerges a part in a chemical bath, and such a machine may have an embodiment of the present invention arranged therein;

FIG. 6B is a cross-sectional view of the machine shown in FIG. 6A;

FIG. 7A is a perspective view of an SR/SF machine that sprays a liquid chemical at a part, and such a machine may have an embodiment of the present invention arranged therein;

FIG. 7B is a view of the machine shown in FIG. 7A in which some of the panels have been removed;

FIG. 8A is a perspective view of a waste water machine for separating solid particles in a chemical solution that had been used in an SR/SF machine, which may have an embodiment of the present invention arranged therein;

FIG. 8B is a schematic of the waste water machine shown in FIG. 8A;

FIG. 8C is a schematic of the waste water machine shown in FIG. 8A;

FIG. 9A is a perspective view of a surface finishing machine that submerges a part in a tank filled with solid abrasives and a chemical solution, which may have an embodiment of the present invention arranged therein;

FIG. 9B is a cross-sectional view of the machine shown in FIG. 9A;

FIG. 10A is a perspective view of a surface finishing machine that submerges a part in a tank filled with solid abrasives and a chemical solution, which may have an embodiment of the present invention arranged therein;

FIG. 10B is a cross-sectional view of the machine shown in FIG. 10A; and

FIG. 10C is a cross-sectional view of the machine shown in FIG. 10A.

### DETAILED DESCRIPTION OF THE INVENTION

At the outset, it should be appreciated that like drawing numbers on different drawing views identify identical, or functionally similar, structural elements of the invention. Furthermore, it is understood that this invention is not limited to the particular methodology, materials, or modifications described and, as such, the invention may vary from that which is disclosed herein. It is also understood that the terminology used herein is for the purpose of describing particular aspects and this invention is not limited to the disclosed aspects.

Unless defined otherwise, all technical and scientific terms used herein have the same meaning as commonly understood to one of ordinary skill in the art to which this invention pertains. It should be understood that any methods, devices or materials similar or equivalent to those described herein can be used in the practice or testing of the method and apparatus.

Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Additionally, as used herein, “determining” is intended to include the act of receiving information from a sensor and executing an algorithm using a general purpose computer or the like, and using that information to produce an output. Additionally, the terms “detergent” and “chemical” are used interchangeably, with the understanding that a detergent can be a single chemical, or a solution comprising of a plurality of different chemicals.

The invention described herein may seek to provide an indication when an improper chemical has been used in an SR/SF machine. As used herein, the phrase “improper fluid” includes improper substances in an SR/FR fluid, as well as an SR/SR fluid having an improper amount of one or more substances.

A first embodiment of the invention uses a sensor that includes a material having one or more qualities that changes when an improper chemical is being used in the machine, such as by transforming from being transparent to opaque. The material can take the form of a chemical composition (or “sample”) in some form that does not change quality, or changes quality over a long period of time, when submerged in a proper chemical, but changes quality more readily when submerged in an improper chemical, for example aggressive chemicals such as IPA, TPM, or KOH. If the proper chemical is not being used, then a warning is provided to the user that an improper chemical is being used, and the sensor may send a signal that results in the SR/SF being shut down, and/or the incident may be recorded for use in future troubleshooting efforts.

In a second embodiment of the invention, a sensor may be arranged within the machine that includes a material that degrades over time when an improper chemical is used. The material can take the form of a chemical composition (or “sample”) in some form that does not dissolve, or dissolves over a long period of time, when submerged in a proper chemical, but dissolves more readily when submerged in an improper chemical, for example aggressive chemicals such as IPA, TPM, or KOH. Eventually the sample dissolves a threshold amount, triggering a signal to inform the user that an improper chemical is being used in the machine. In addition, the machine could include a system that automatically shuts down the machine in order to prevent further damage to the parts being processed or internal components of the machine. Further, such an automatic shutdown system could require resetting or replacing the sensor.

A sensor mechanism could include a light sensor (e.g., the sample changes from transparent to opaque in an improper chemical and the inability of light to pass through it is detected), force sensor (e.g. the sample degrades in an improper chemical and thereby allows for mechanical motion that is detected), color light sensor (e.g. the sample dissolves in an improper chemical, altering the color of the chemical outside a threshold value, and that color is then detected), viscometers (e.g. the sample dissolves in an improper chemical, altering the viscosity of the chemical outside a threshold value, and that viscosity is detected), and/or thermal conductivity sensor (the sample dissolves in an improper chemical, altering the thermal conductivity of the chemical, and that thermal conductivity is detected). However, it is important to note that other suitable sensors might be used to detect the reaction of a sample with the chemical used in the SR/SF process or otherwise detect an improper chemical.

An example of the chemical compositions (samples) that could be used for the sensor when placed in highly caustic solutions (for example, a 45% KOH solution) are: Extruded Acrylic, Polyethylene terephthalate (PETG), Polycarbonate, Cellulose Acetate, or another suitable material which would react with highly caustic solutions. An example of the chemical compositions that could be used for the sensor when placed in high-concentration IPA or TPM solutions are: Polyacrylate, Polyurethane, or another suitable material that reacts with high-concentration IPA or TPM. Multiple sensors can be used in a single SR/SF machine for compatibility with a wide range of printer materials and manufacturing processes. Embodiments of the present invention can be used in submersible, spray, and/or waste water machines for SR/SF processes.

A current option for SR/SF of additive manufactured parts involves concentrated chemicals or intensive manual labor. Certain automated machines, such as those available from PostProcess Technologies, Inc., use a combination of (1) chemistry, (2) apparatuses, and (3) methods to increase the efficiency of the SR/SF system. All three of these may work in combination and interact with one another.

For example, automated machines can be set to heat only the part to a specified maximum temperature, such as 105° F. If a higher temperature were used, it could easily affect the geometry of the part being SR/SF processed and ruin the part due to deformations caused by heat that exceeds limitations of the material from which the part is made. Proper chemicals for use in such machines can be formulated to work in combination with the temperature limitations to provide an acceptable processing time for SR/SF processing of a part. Additionally, proper chemicals can be formulated to not require a high operating temperature and yet achieve a desired processing time.

If an improper chemical is used in a machine, it could affect the quality of the SR/SF process and processing time. It could also damage the machine, and this is especially true when an improper chemical is a very aggressive chemical, such as IPA, where it could react poorly with calibrated components of the machine. It would be beneficial to alert the user of a machine if a proper chemical is not being used. In addition to the deleterious effects on the machine components and/or additive manufactured part, using an improper chemical could void the machine manufacturer's warranty.

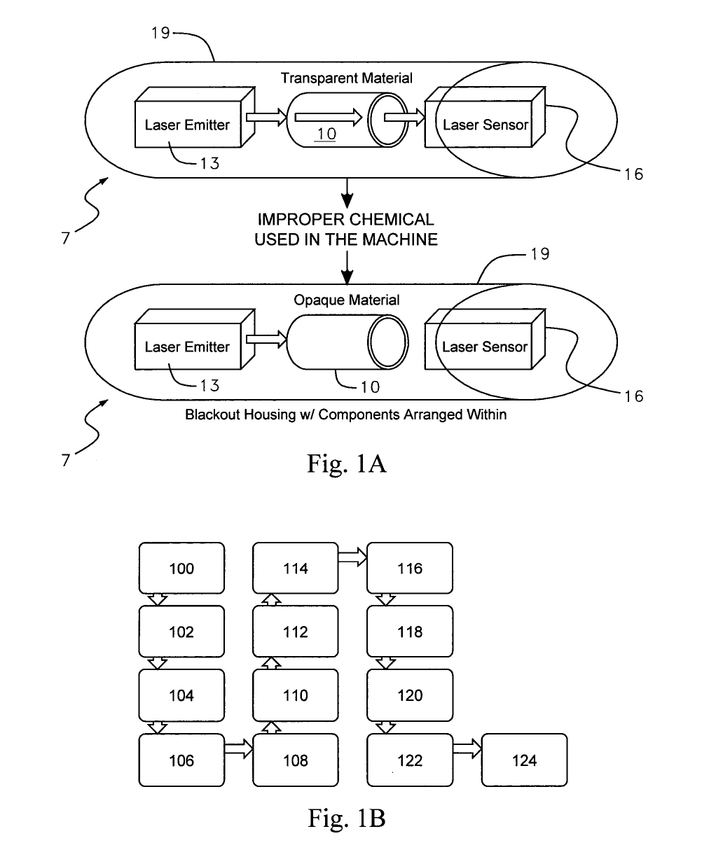

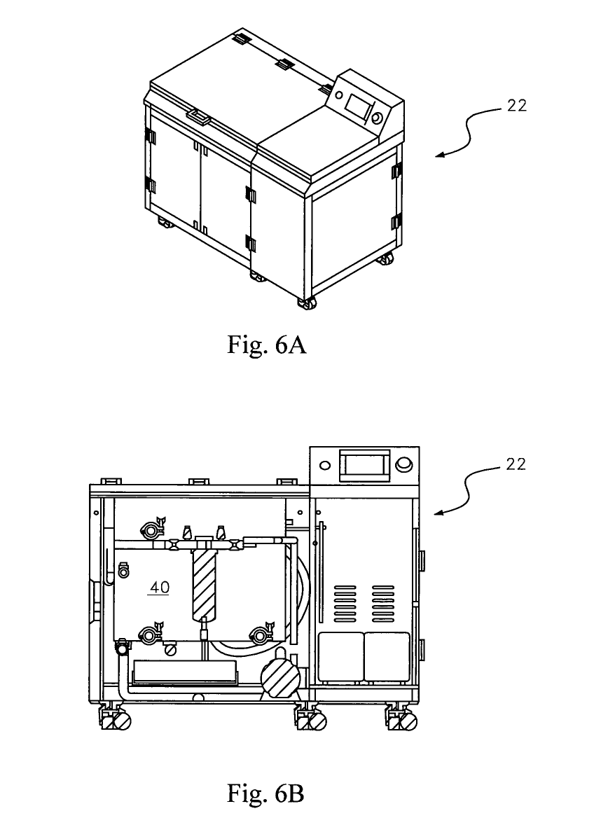

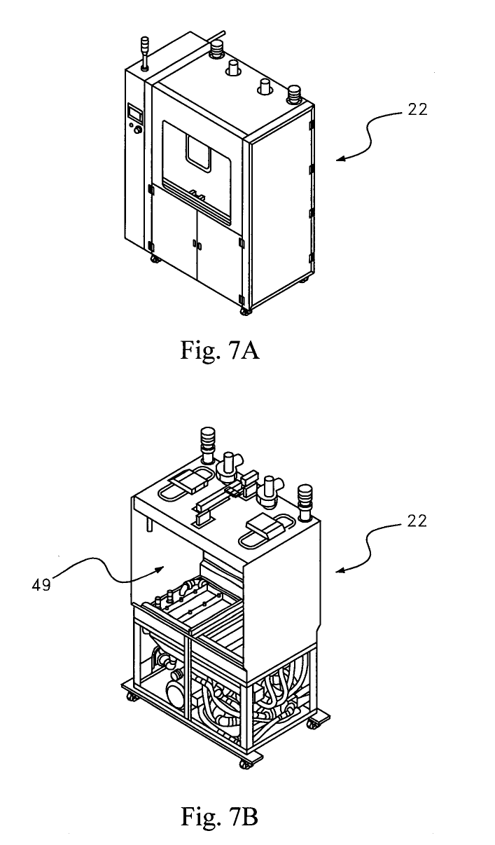

Adverting now to the figures, FIG. 1A is a schematic view of a first embodiment of a chemical detection apparatus 7. In that first embodiment, if an improper chemical is placed in the machine, the sample 10 would turn from transparent to opaque, blocking the laser light emitted from the laser 13 from passing through the sample 10 and to the laser sensor 16. A new machine may come preloaded with a clear, transparent sensor sample 10 arranged in a housing 19 which holds the sample 10 in line with the laser emitter 13 and laser sensor 16. The manner of arranging the laser sensor 16, or sample 10 portion of the apparatus 7 within a machine will depend on the nature of a machine 22. For example, when used in the machine 22 that submerses the part in a chemical such as the machine 22 shown in FIG. 6A, the sample 10 would be submerged in the chemical in the machine 22. When used in a spray machine 22 such as shown in FIG. 7A, the sample 10 would be held in a housing 19 that allows the chemical being processed through the machine 22 to pass over the sample 10. The sample 10 needs to be arranged where sufficient chemical would interact with the sample 10 during the SR/SF processing of a part. As the machine 22 processes parts, the sensor remains transparent as long as a proper chemical is used in the machine 22 (or at least for a very long time while a proper chemical is used), but would become opaque if an improper chemical is used.

It is important to note that the sample 10 could begin as an opaque material and turn transparent in the presence of IPA, TPM, or a highly caustic environment. In that case, the sensor would detect the presence rather than absence of light passing through the sample 10. Additionally, the time frame that is required for the sample 10 to change could vary from instantaneously to over a longer period of time, such as a few days, weeks, or months. Furthermore, the sensitivity of the chemical detection apparatus 7 could be adjusted to require more or less opaqueness (or transparency) before a signal is sent to indicate that an improper chemical has been used. For example, such an adjustment could be made by changing a threshold value coded in the software which controls the laser emitter 13 and sensor 16. Also, the sample 10 does not need to turn completely opaque, but could become merely less transparent to an extent sufficient to exceed the threshold value. The sample 10 can be any suitable shape, such as a sheet, cylinder, square, puck, or sphere.

FIG. 1B is a flowchart describing a chemical detection method according to a first embodiment of the present invention. Step 100 includes arranging a sample 10 in a housing 19. The housing 19 is arranged within a machine 22 such as those depicted in FIGS. 6A, 7A, 8A, 9A and 10A. Also arranged within the housing 19 is a light emitter 13, such as a laser, situated at a proximate end of the sample 10, with a light/laser sensor 16 situated on an opposite, distal end of the sample 10. Step 102 includes turning on the light emitter 13 to project light though the sample 10, with the resultant light being detected by the light sensor 16. The housing 19 is used to prevent or minimize ambient light from reaching the light sensor 16. The housing 19 may be arranged in such a way that a chemical or liquid used in the machine 22 will adequately flow over and around the sample 10. This will guarantee that the sample 10 will be subjected to the chemical being used in the SR/SF process. Step 104 includes starting the SR/SF process by placing the additive manufactured part in the machine and starting the machine. The part is then subjected to processing, such as fluid flow and heat and/or agitation, over a period of time to remove the support material and/or finish the surface of the part. Step 106 includes flowing the chemical being used in the SR/SF process over the sample 10. Step 108 includes measuring (e.g. measured by the sensor 16) the amount of light passing through the sample 10 at multiple times during operation of the machine 22 or continuously. Step 110 includes comparing the amount of measured light to a threshold value that is defined in the operating software of the machine 22. Step 112 includes generating an alert, automatically shutting down the machine 22 and/or preventing start-up of the machine 22 if the amount of resultant light is not above the threshold value. If the amount of measured light is below the threshold value, the sample 10 may have become less transparent to a point where it could be determined that an improper chemical was used for more than a predetermined allowable period of time. This threshold value could be set to allow some processing or a small time period where the improper chemical could be used, or could be set to prevent any processing from being done if an improper chemical is used in the machine 22. Step 114 includes replacing the sample 10 with a new sample 10, which would be transparent. Step 116 includes turning on the machine 22 with the new sample 10 placed in the housing 19. Step 118 includes measuring the amount of resultant light passing through the new sample 10. Step 120 includes comparing the amount of resultant light detected by the sensor 16 with the threshold value. Step 122 includes unlocking the machine 22 if the amount of resultant light is greater than the threshold value. Step 124 includes logging an instance of shut down due to improper chemical use in a troubleshooting database. Step 124 could occur earlier in the process, such as immediately after step 112. The database could be devised so that it may only be accessed by specific individuals, such as service personnel responsible for maintaining the machine 22, at a later time.

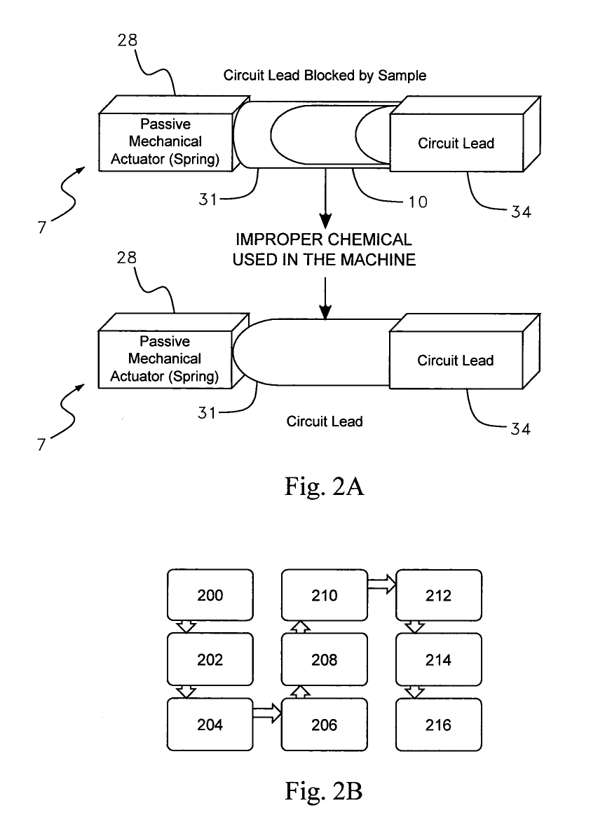

FIG. 2A is a schematic view of a second embodiment of the chemical detection apparatus 7. In this second embodiment, if improper chemical is placed in the machine 22, the sample 10 would degrade over time, allowing mechanical motion of a plunger 31 to close an electrical circuit. For example, a sample 10 could be keeping two parts 31, 34 of a circuit from completing an electrical circuit. When the sample 10 degrades as a result of using an improper chemical, the electrical circuit completes and triggers a spring to close a valve that prevents the machine 22 from operating. It could also, or alternatively, generate an alert to inform the user that an improper chemical has been used. For example, the sample 10 could be designed to degrade in IPA, TPM or a highly caustic environment.

FIG. 2B is a flowchart describing the chemical detection method according to the second embodiment of the present invention. Step 200 includes operatively arranging a sample 10 within the apparatus 7. Arranged on a distal end of the apparatus 7 is a passive mechanical force, such as a spring 28, which will apply a force to a plunger 31 that contacts the sample 10. Arranged on the distal end of the sample 10 is a circuit lead 34 which is blocked from contact with plunger 31 as long as the sample 10 is in place. The apparatus 7 may be arranged within a machine 22. The apparatus 7 may be arranged in such a way that any chemical or liquid used in the machine 22 will flow over and around the sample 10. This will guarantee that the sample 10 will be subjected to the chemical being used in the SR/SF process. Step 202 includes starting the machine 22, where an additive manufactured part having support material has been placed in the apparatus 7. The part is then subjected to SR/SF processing, such as fluid flow and heat and/or agitation, over a period of time to remove the support material. Step 204 includes flowing the chemical being used in the SR/SF process over the sample 10 during the SR/SF process. Step 206 includes generating an alert, automatically shutting down the machine 22 and/or preventing start-up of the machine 22 if the plunger 31 comes into contact with circuit lead 34, thereby completing the electrical circuit. If the plunger 31 touches the lead 34, it means that the sample 10 has been dissolved by an improper chemical. Step 208 includes replacing the sample 10 with a new sample 10, which would depress the extendable plunger 31 back into the passive mechanical actuator 28. Step 210 includes turning on the machine 22 with the new sample 10 placed in the apparatus 7. Step 212 includes determining if the circuit is open. Step 214 includes unlocking the machine 22 if the circuit is not open. Step 216 includes logging an instance of shut down due to improper chemical use in a troubleshooting database. Step 216 could occur earlier in the process, such as immediately after step 206. The troubleshooting database may be devised so that it may only be accessed by specific individuals, such as service personnel responsible for maintaining the machine 22.

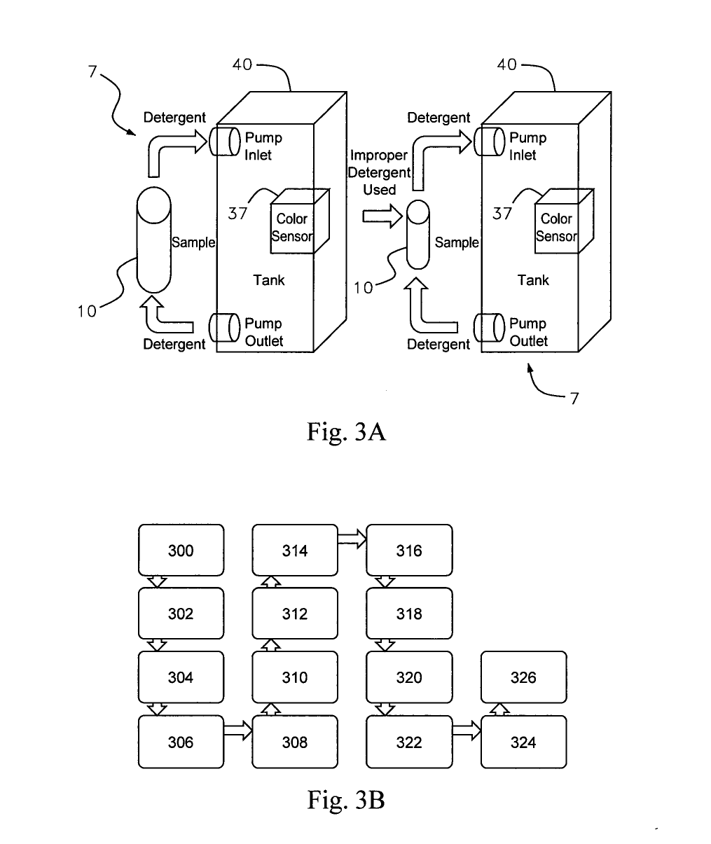

FIG. 3A is a schematic view of a third embodiment of a chemical detection apparatus 7. In this third embodiment, if an improper chemical is placed in the machine 22, the sample 10 would react with the improper chemical (such as IPA, TPM or a high caustic environment), with the resulting chemical solution changing color and then detected by a color sensor 37 arranged in the tank 40. The sample 10 may be made from a similar material as in the second embodiment described above, but further includes a color-changing agent. Examples of color-changing agents include carbon black or another suitable color dye/color-changing agent. Over time, as the sample 10 dissolves, the improper chemical would slowly change color, thereby indicating that the chemical is improper. Additionally, this third embodiment could be used with the second embodiment of the apparatus 7 to detect when the color-changing sample 10 is completely dissolved, thus triggering the sensor 37 to send a signal. This would prevent a user from being able to continue using an improper chemical by simply dissolving the color-changing sample 10 prior to using the machine and then replacing the dyed chemical with new improper chemical. The color sensor 37 could be the Endress+Hauser Inc. Color Sensor OUSAF22.

FIG. 3B is a flowchart describing the chemical detection method according to the third embodiment of the present invention. Step 300 includes arranging a sample 10 in a housing 19 which will hold the sample 10 in place while allowing the chemical used in the SR/SF process to adequately interact with the sample 10. The housing 19 is arranged within the SR/SF machine 22 such as those depicted in FIGS. 6A, 7A, 8A, 9A and 10A. Step 302 includes starting the process, where a part is placed in the same machine as the housing 19. The part is then subjected to processing, such as fluid flow and heat and/or agitation, over a period of time to remove the support material. Step 304 includes taking a color measurement of the chemical used in the SR/SF process via a color sensor 37 arranged in the tank 40. The color sensor 37 can also be arranged in another location as long as the color sensor 37 can interact with the chemical. Step 306 includes flowing the chemical being used in the process over the sample 10 during the SR/SF process. Step 308 includes releasing a color changing agent embedded in the sample 10 into the chemical during the SR/SF process if an improper chemical is used, due to a reaction between the improper chemical and the sample 10. This color changing-agent will change the color of the chemical such that the color sensor 37 detects the color change. It may also be the case that a user could see the change with the naked eye. Step 310 includes taking a color measurement of the chemical used in the SR/SF process via the color sensor 37. Step 312 includes comparing the first color measurement and the second color measurement to determine if the color change is outside a threshold value which may be part of the operating software of the machine 22. A threshold value is used since the chemical would naturally become darker/dirty due to removal of support material and/or as a result of surface finishing, and by foreign bodies entering the chemical such as dust and dirt. Step 314 includes shutting down the machine 22 or preventing start-up of the machine 22 if the color change is above the threshold value. If the color change amount is above the threshold value, this means that the sample 10 has dissolved enough such that enough color agent has entered the chemical that it could be determined that an improper chemical was used for a period of time. The threshold value could be set to allow some SR/SF processing during which the improper chemical could be used, or could be set to prevent any operation of the machine 22 if an improper chemical is used in the machine 22. Step 316 includes replacing the sample 10 with a new sample 10, which would contain more color changing agent. Step 318 includes turning on the machine 22 with the new sample 10 placed in the housing 19. Step 320 includes replacing the chemical in the machine 22 with new chemical. Step 322 includes measuring the color of the new chemical in the machine 22 via the color sensor 37. Step 324 includes unlocking the machine 22 if the color of the new chemical is below the threshold value. Step 326 includes logging an instance of shut down due to improper chemical use in a troubleshooting database. Step 326 could occur earlier in the process, such as immediately after step 314. The troubleshooting database may be devised so that it may only be accessed by specific individuals, such as service personnel responsible for maintaining the machine 22.

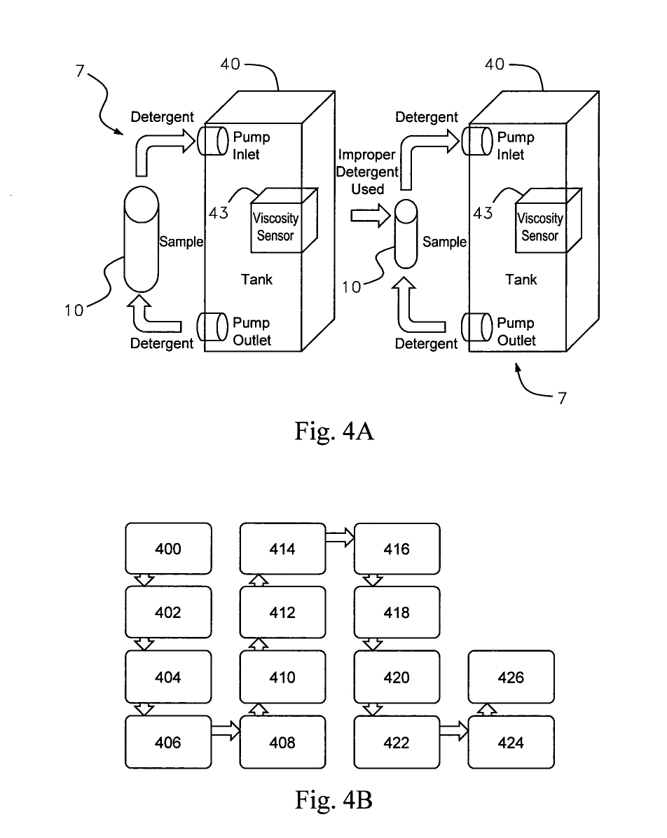

FIG. 4A is a schematic view of a fourth embodiment of the chemical detection apparatus 7. In a fourth embodiment, if an improper chemical is placed in the machine 22, the sample 10 (containing a viscosity altering agent such as vegetable gums, starches, gelatins, pectin, or any other suitable thickening agent) would react with the improper chemical (such as IPA, TPM or a high caustic environment), altering the viscosity of the chemical outside a threshold value (for example, +/−1%) which is then detected by a viscosity sensor 43. The viscosity sensor 43 can be arranged in-line with the pump flow or within the tank 40. Additionally, this embodiment of the invention could be used without a dissolving sample 10, but instead with just a viscosity sensor 43 which detects the viscosity of the chemical being used. If the viscosity of the chemical being used is not within a predetermined range of the proper chemical, the machine 22 would prevent the machine from operating and inform the user that an improper chemical is being used.

FIG. 4B is a flowchart describing the chemical detection method according to the fourth embodiment of the present invention. Step 400 includes arranging a sample 10 in a housing 19 which will hold the sample 10 in place while allowing the chemical used in the process to adequately interact with the sample 10. The housing 19 is arranged within a machine 22 such as those depicted in FIGS. 6A, 7A, 8A, 9A and 10A. Step 402 includes starting the SR/SF process, where a part having support material is placed in the same machine as the housing 19. The part is then subjected to processing, such as fluid flow and heat and/or agitation, over a period of time to remove the support material and/or finish the surface of the part. Step 404 includes taking a viscosity measurement of the chemical used in the process via a viscosity sensor 43 arranged in the tank 40. The viscosity sensor 43 can also be arranged in another location as long as the viscosity sensor 43 can interact with the chemical. Step 406 includes flowing the chemical being used in the SR/SF process over the sample 10 during the SR/SF process. Step 408 includes releasing a viscosity changing agent embedded in the sample 10 into the chemical during the process if a chemical is improper, due to a reaction between the improper chemical and the sample 10. This viscosity changing agent will change the viscosity of the chemical and the viscosity sensor 43 will detect the change. It may also be the case that a user could see with the naked eye that the viscosity of the chemical has changed. Step 410 includes taking a viscosity measurement of the chemical used in the SR/SF process via the viscosity sensor 43. Step 412 includes comparing the first viscosity measurement and the second viscosity measurement to determine if the viscosity change is outside a threshold value which may be part of the operating software of the machine 22. A threshold value is used since the chemical would naturally become dirty due to use from support material removal and/or surface finishing and by foreign bodies such as dust and dirt entering the chemical. Step 414 includes shutting down the machine 22 in which the housing 19 is arranged or preventing start-up of the machine 22 if the viscosity change is above the threshold value. If the viscosity change is above the threshold value, this means that the sample 10 has dissolved enough such that enough viscosity agent has entered the chemical such that it can be determined that an improper chemical was used. This threshold value could be set to allow some SR/SF processing or a small time period where an improper chemical could be used, or could be set to prevent any SR/SF processing from being carried out via the machine 22 if an improper chemical is used in the machine 22. Step 416 includes replacing the sample 10 with a new sample 10, which would contain more viscosity changing agent. Step 418 includes turning on the machine 22 with the new sample 10 placed in the housing 19. Step 420 includes replacing the chemical in the machine 22 with new chemical. Step 422 includes measuring the viscosity of the new chemical in the machine via the viscosity sensor 43. Step 424 includes unlocking the machine 22 if the new chemical has a viscosity below a lower threshold value or above an upper threshold value.

Step 426 includes logging an instance of a shut down due to improper chemical use in a troubleshooting database. Step 426 could occur earlier in the process, such as immediately after step 414. The troubleshooting database may be devised so that it may only be accessed by specific individuals, such as service personnel responsible for maintaining the machine 22.

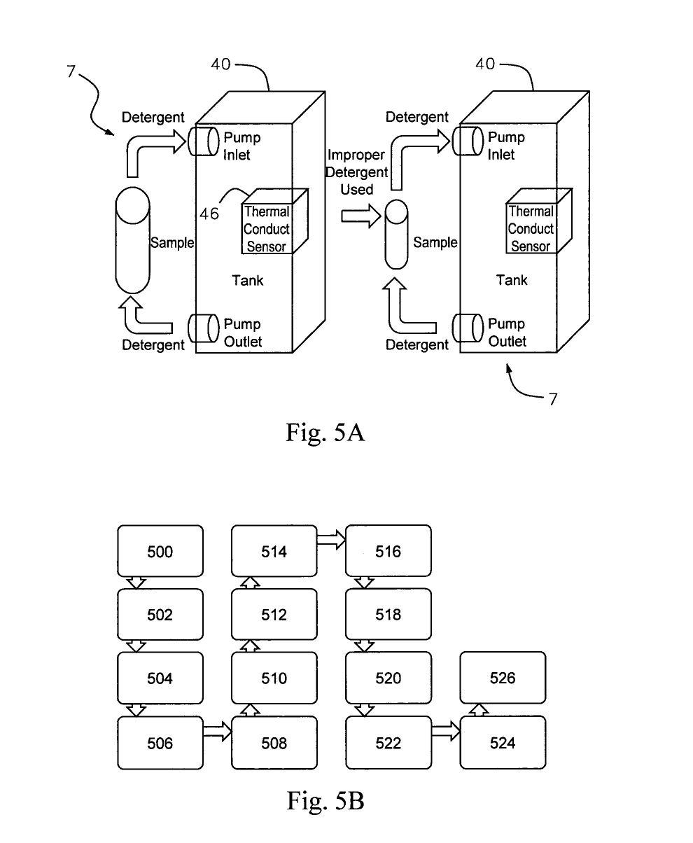

FIG. 5A is a detailed schematic view of a fifth embodiment of a chemical detection apparatus 7. In a fifth embodiment, if an improper chemical is placed in the machine 22, the sample 10 would react with the improper chemical (such as IPA, TPM or a high caustic environment), altering the thermal conductivity of the chemical formulation. This embodiment could be calibrated to detect the thermal conductivity of proper chemicals and alert a user if a chemical being used does not have the desired thermal conductivity. Additionally, this embodiment could be calibrated to have a sample 10 which would dissolve or react with improper chemicals such as IPA, TPM, or a highly caustic environment, and the sample 10 contains a compound which would alter the thermal conductivity of the chemical sufficiently to be detected by a thermal conductivity sensor 46. This embodiment of the invention would then detect the change in thermal conductivity of the chemical from the beginning of an SR/SF process while the SR/SF process is being performed. If the chemical is an improper chemical, the sample 10 would dissolve, thereby altering the thermal conductivity of the chemical. Additionally, this embodiment could be used with the mechanical sensor embodiment to detect when the sample 10 is completely dissolved. This would prevent a user from continuing to use an improper chemical by simply dissolving the sample 10 prior to using the machine 22 and replacing the altered chemical with new improper chemical.

FIG. 5B is a flowchart describing the chemical detection method according to the fifth embodiment of the present invention. Step 500 includes arranging a sample 10 in a housing 19 which will hold the sample 10 in place while allowing the chemical used in the SR/SF process to interact with the sample 10. The housing 19 may be arranged within a machine 22 such as those depicted in FIGS. 6A, 7A, 8A, 9A and 10A. Step 502 includes starting the SR/SF process, where a part having support material is placed in the same machine 22 as the housing 19. The part is then subjected to processing, such as fluid flow and heat and/or agitation, over a period of time to remove the support material and/or finish a surface of the part. Step 504 includes taking a thermal conductivity measurement of the chemical used in the process via a thermal conductivity sensor 46 arranged in the tank. The thermal conductivity sensor 46 can also be arranged in another location as long as the thermal conductivity sensor 46 can interact with the chemical. Step 506 includes flowing the chemical being .used in the process over the sample 10 during the process. Step 508 includes releasing a thermal conductivity-changing agent embedded in the sample 10 into the chemical during the SR/SF process if an improper chemical is used, due to a reaction between the improper chemical and the sample 10. This thermal conductivity-changing agent will change the thermal conductivity of the chemical. Step 510 includes taking a thermal conductivity measurement of the chemical used in the process via the thermal conductivity sensor 46. Step 512 includes comparing the first thermal conductivity measurement and the second thermal conductivity measurement to determine if the thermal conductivity change is outside a threshold value, which may be part of the operating software of the machine 22. A threshold value may be used since the chemical would naturally become dirty due to use from support material removal, surface finishing, and by foreign bodies entering the chemical such as dust and dirt. Step 514 includes shutting down the machine 22 in which the housing 19 is arranged or preventing start-up of the machine 22 if the thermal conductivity change is above the threshold value. If the thermal conductivity change is above the threshold value, this means that the sample 10 has dissolved enough so that enough thermal conductivity agent has entered the chemical where it could be determined that an improper chemical was used. This threshold value could be set to allow some SR/SF processing or a small time period where the improper chemical could be used, or could be set to prevent any SR/SF processing if an improper chemical is used in the machine 22. Step 516 includes replacing the sample 10 with a new sample 10, which would contain more thermal conductivity-changing agent. Step 518 includes turning on the machine 22 with the new sample 10 placed in the housing 19. Step 520 includes replacing the chemical in the machine 22 with new chemical. Step 522 includes measuring the thermal conductivity of the new chemical in the machine via the thermal conductivity sensor 46. Step 524 includes allowing the machine 22 to operate if the new chemical has a thermal conductivity within the threshold value. Step 526 includes logging an instance of a shut down due to improper chemical use in a troubleshooting database. Step 526 could occur earlier in the process, such as immediately after step 514. The troubleshooting database may be devised so that it may only be accessed by specific individuals, such as service personnel responsible for maintaining the machine 22.

FIG. 6A is a perspective view of an SR/SF machine 22 that could have a detection apparatus 7 according to the present invention arranged therein. The machine 22 could be the DEMI, CENTI, MILLI, MICRO, NANO or PICO available from PostProcess Technologies, Inc.

FIG. 6B is a cross-sectional view of the machine 22 shown in FIG. 6A. An embodiment of the present invention could be placed directly within the tank 40 to interact with the chemical or placed in a location among the plumbing which connects a pump to the tank 40.

FIG. 7A is a perspective view of an SR/SF machine 22 that sprays a liquid chemical at a part, and that could have a detection apparatus 7 according to the present invention arranged therein. The machine 22 could be the BASE, DECI or DECI DUO available from PostProcess Technologies, Inc.

FIG. 7B is a view of the machine 22 shown in FIG. 7A. A chemical detection apparatus 7 according to the present invention could be placed directly within the chamber 49 to interact with the chemical or placed in a location among the plumbing which connects a pump to the spray nozzles arranged within the chamber 49.

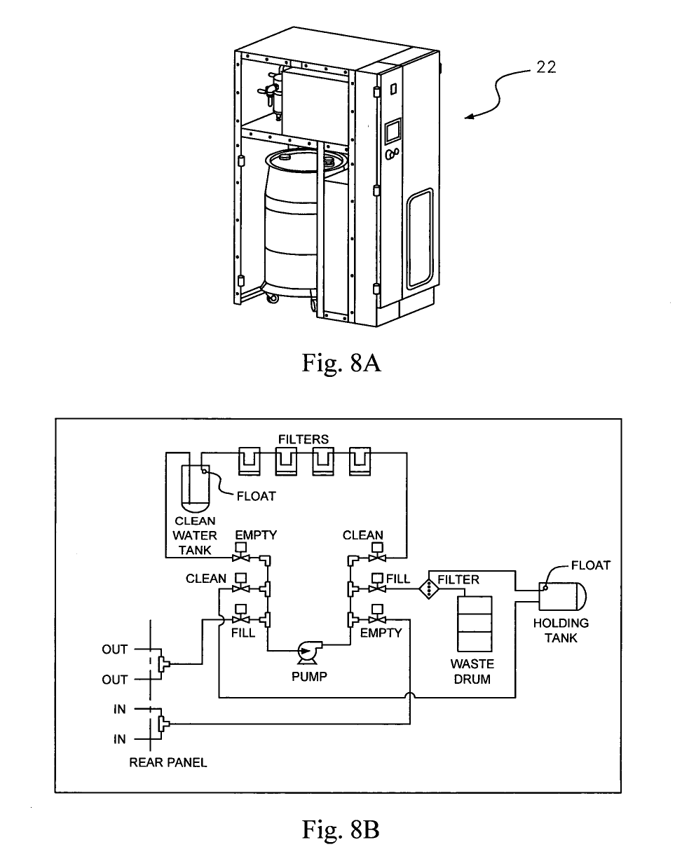

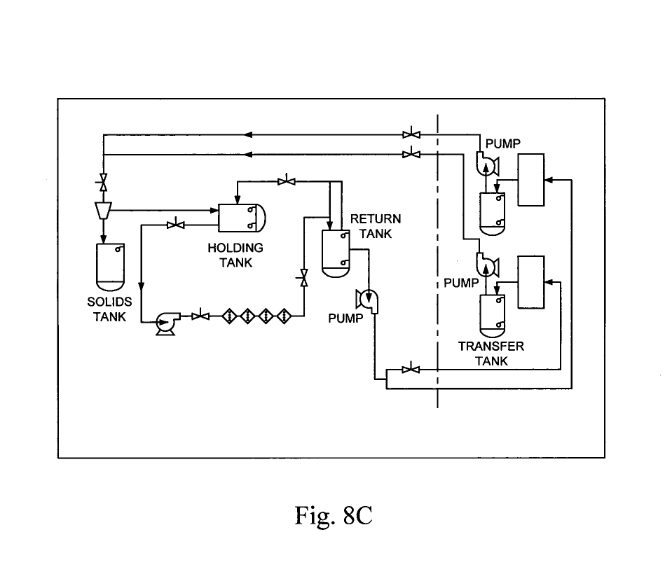

FIG. 8A is a perspective view of a waste water machine 22 that could have a chemical detecting apparatus 7 according to the present invention arranged therein. The machine 22 could be the PWM Solution available from PostProcess Technologies, Inc. An embodiment of the present invention could be placed at a location inline with the fluid connections arranged within the waste water system to help detect attrition rates of finishing media or changes in chemical properties caused by a sample 10 dissolving in improper chemicals.

FIG. 8B is a schematic of the waste water machine shown in FIG. 8A.

FIG. 8C is a schematic of the waste water machine shown in FIG. 8A.

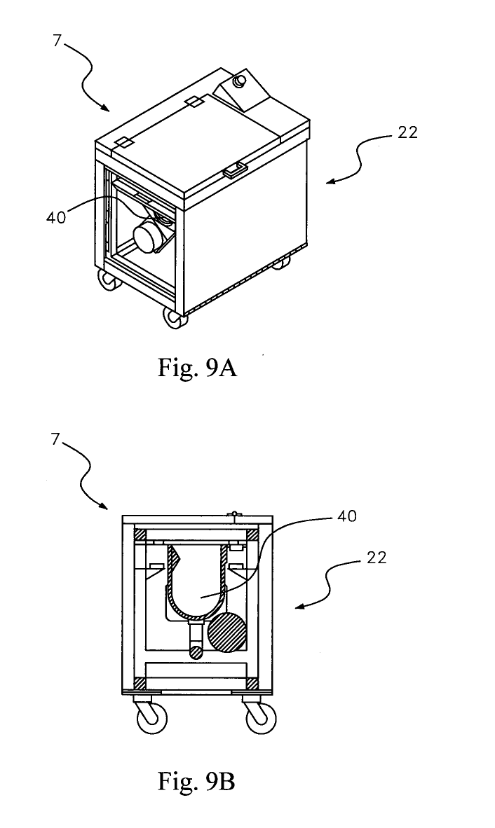

FIG. 9A is a perspective view of an SR/SF machine 22 that could have a chemical detecting apparatus 7 according to the present invention arranged therein. The machine 22 could be the LEVO or RADOR available from PostProcess Technologies, Inc. An embodiment of the present invention could be placed at a location inline with the fluid connections to help detect attrition rates of finishing media or changes in chemical properties caused by a sample 10 dissolving in improper chemicals.

FIG. 9B is a cross-sectional view of the machine 22 shown in FIG. 9A.

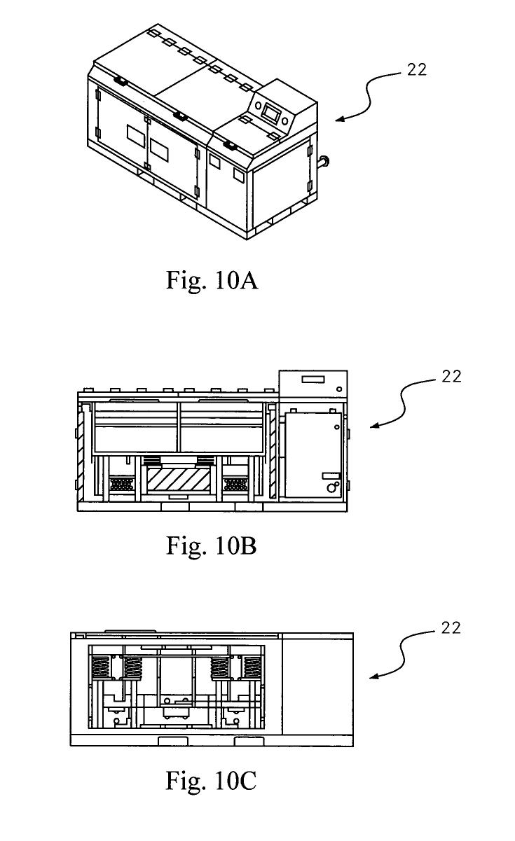

FIG. 10A is a perspective view of an SR/SF machine 22 that could have a chemical detecting apparatus 7 according to the present invention arranged therein. The machine 22 could be the NITOR available from PostProcess Technologies, Inc. An embodiment of the present invention could be placed at a location inline with the fluid connections to help detect attrition rates of finishing media or changes in chemical properties caused by a sample 10 dissolving in improper chemicals.

FIG. 10B is a cross-sectional view of the machine 22 shown in FIG. 10A.

FIG. 10C is a cross-sectional view of the machine 22 shown in FIG. 10A. The machines 22 depicted in FIGS. 9A and 10A may utilize media comprising of a plurality of abrasive bodies that interact with the outer surface of an additive manufactured part placed within the machine 22. As the media is used over a plurality of cycles, the media itself begins to break down, which is sometimes referred to as media attrition. A lubricant/chemical may be added to the media during the SR/SF process to slow down the media attrition and to aid in flushing broken down media particles out of the main tank 40. A chemical detecting apparatus 7 according to an embodiment of the present invention could be used to detect the attrition rate of finishing media and determine if the proper media and/or lubricant/chemical is being used in the SR/SF process. If the samples 10 of the previous embodiments were replaced with a media having the following properties, similar methods and apparatuses of the previous embodiments could be used to detect media attrition. For example, in the first embodiment, the media could begin clear/transparent and become opaque either from media attrition or lubricant interaction. In the third embodiment, the media could release a color-changing agent as media attrition occurs from use of an improper lubricant. In the fourth embodiment, the media could release a viscosity-changing agent as media attrition occurs from use of an improper lubricant. In the fifth embodiment, the media could release a thermal conductivity-changing agent as media attrition occurs from use of an improper lubricant. The excessive media attrition could be measured by the media remaining in the tank 40 or by measuring the rate of media attrition contained within the lubricant/chemical which is drained from the tank 40 during the surface removal process.

Example embodiments of the invention are described in the foregoing description, which includes the drawings. The description is accordingly to be regarded in an illustrative rather than a restrictive sense.

It will be appreciated that various aspects of the above-disclosed invention and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. An apparatus for detecting whether a liquid comprising one or more improper substances or improper amounts of one or more substances (“improper fluid”) has been added to a system for removing support material from and/or smoothing a surface of a part made by additive manufacturing (the “AM part”), comprising:
a sample material that is altered if the improper fluid contacts the sample material, wherein said alteration is due to characteristics of the improper fluid at the time it is added to the system; and
a sensor capable of detecting whether the sample material has been altered.

2. The apparatus of claim 1, wherein a translucence of the sample material is altered if the improper fluid contacts the sample material.

3. The apparatus of claim 2, wherein said sensor includes a light detector.

4. The apparatus of claim 2, wherein the sensor includes a light source positioned on a first side of the sample material, and a light detector positioned on a second side of the sample material.

5. The apparatus of claim 1, wherein the sample material is capable of chemically reacting with the improper fluid.

6. The apparatus of claim 1, further comprising a device that prevents the system from operating or provides a notification, or both, if the sensor detects that the sample material has been altered.

7. The apparatus of claim 1, further comprising an electronic circuit electrically coupled to the sensor, the electronic circuit being capable of preventing the system from removing support material from and/or smoothing a surface of the AM part if the sensor detects that the sample material has been altered.

8. The apparatus of claim 1, wherein the alteration of the sample material is a degrading or dissolving of the sample material caused by contact with the improper fluid.

9. The apparatus of claim 8, wherein the sensor completes an electrical circuit when the sample material degrades or dissolves.

10. The apparatus of claim 8, wherein the sensor includes a plunger positioned on a first side of the sample material, and a conductor positioned on a second side of the sample material.

11. The apparatus of claim 1, wherein the sample material releases a color-changing substance if the improper fluid contacts the sample material thereby altering a color of the improper fluid, and wherein the sensor detects a color of the improper fluid.

12. The apparatus of claim 1, wherein the sample material releases a viscosity-changing substance if the improper fluid contacts the sample material thereby altering a viscosity of the improper fluid, and wherein the sensor detects a viscosity of the improper fluid.

13. The apparatus of claim 1, wherein the sample material releases a thermal-conductivity-changing substance if the improper fluid contacts the sample material thereby altering a thermal conductivity of the improper fluid, and wherein the sensor detects a thermal conductivity of the improper fluid.

14. A system for removing support material from and/or smoothing the surface of a part made by additive manufacturing (the “AM part”), comprising:
a detector capable of detecting whether a liquid comprising an improper substance or improper amount of a substance (“improper liquid”) has been added to the system, said detector having:
a sample material that is altered if contacted by the improper liquid; and
a sensor capable of detecting if the sample material has been altered.

15. The system of claim 14, further comprising a device that prevents the system from operating or provides a notification, or both, if the sensor detects that the sample material has been altered.

16. The system of claim 14, wherein the sample material is capable of chemically reacting with the improper liquid.

17. The system of claim 14, further comprising an electronic circuit electrically coupled to the sensor, the electronic circuit being capable of preventing the system from removing support material from and/or smoothing a surface of the AM part if the sensor detects that the sample material has been altered.

18. The system of claim 14, wherein a translucence of the sample material is altered if the improper liquid contacts the sample material, and wherein the sensor includes a light source.

19. The system of claim 18, wherein the sensor includes a light detector positioned on a first side of the sample material, and the light source is positioned on a second side of the sample material.

20. The system of claim 14, wherein the sample material is capable of degrading or dissolving if the improper liquid contacts the sample material.

21. The system of claim 20, wherein the sensor includes a plunger positioned on a first side of the sample material, and a conductor positioned on a second side of the sample material.

22. The system of claim 14, wherein the sample material releases a color-changing substance if the improper liquid contacts the sample material, thereby altering a color of the improper liquid, and the sensor includes a color-detector.

23. The system of claim 14, wherein the sample material releases a viscosity-changing substance if the improper liquid contacts the sample material thereby altering a viscosity of the improper liquid, and the sensor includes a viscosity-detector.

24. The system of claim 14, wherein the sample material releases a thermal-conductivity-changing substance if the improper liquid contacts the sample material thereby altering a thermal conductivity of the improper liquid, and the sensor includes a thermal-conductivity-detector.

25. A method of detecting whether a liquid comprising one or more improper substances or improper amounts of one or more substances (“improper fluid”) has been added to a system for removing support material from and/or smoothing a surface of a part made by additive manufacturing (the “AM part”), comprising:
providing a sample material that is altered if the improper fluid contacts the sample material, wherein said alteration is due to characteristics of the improper fluid at the time it is added to the system; and
providing a sensor capable of detecting whether the sample material has been altered;
using the sensor to detect that the sample material has been altered.

26. The method of claim 25 wherein using the sensor to detect includes detecting a translucence of the sample material.

27. The method of claim 25, wherein using the sensor to detect includes detecting that the sample material has degraded or dissolved.

28. The method of claim 27, wherein detecting that the sample material has degraded or dissolved includes monitoring an electrical circuit to determine whether a state of the circuit as either open or closed has changed to the opposite state.

29. The method of claim 25, wherein using the sensor to detect includes detecting a color of the improper fluid.

30. The method of claim 25, wherein using the sensor to detect includes detecting a viscosity of the improper fluid.

31. The method of claim 25, wherein using the sensor to detect includes detecting a thermal conductivity of the improper fluid.

32. The method of claim 25, further comprising preventing the system from operating or providing a notification, or both, if the sensor detects that the sample material has been altered.

33. The method of claim 25, further comprising preventing the system from removing support material from and/or smoothing a surface of the AM part if the sensor detects that the sample material has been altered.
